(19) United States
(12) Patent Application Publication
(10) Pub. No.: US 2024/0165881 A1
(43) Pub. Date: May 23, 2024

(54) RELATIVELY ROTATED OBJECTS

(71) Applicant: Hewlett-Packard Development Company, L.P., Spring, TX (US)

(72) Inventors: Jordi ROCA VILA, Sant Cugat del Valles (ES); Sergio GONZALEZ MARTIN, Sant Cugat del Valles (ES); Cristina GONZALEZ DELGADO, Sant Cugat del Valles (ES)

(21) Appl. No.: 18/283,791

(22) PCT Filed: Mar. 29, 2021
(86) PCT No.: PCT/US2021/024691

§ 371 Date: Sep. 23, 2023

(51) Int. Cl. B29C 64/386; B33Y 50/00

(52) U.S. Cl. CPC B29C 64/386; B33Y 50/00

(57) ABSTRACT

In an example, a method includes obtaining a plurality of models each representing an object to be generated in an additive manufacturing operation. In some examples the method further includes identifying a set of models of the plurality of models which represent instances of similar objects. The method may include determining whether the objects represented by the models of the set of models are to be generated relatively rotated with respect to one another. In some examples the method further includes, when the objects represented by the set of models are to be generated relatively rotated with respect to one another, providing an indication of the relative rotation.

### BACKGROUND

Additive manufacturing techniques may generate a three-dimensional object through the solidification of a build material, for example on a layer-by-layer basis. In examples of such techniques, build material may be supplied in a layer-wise manner and the solidification method may include heating the layers of build material to cause melting in selected regions. In other techniques, chemical solidification methods may be used.

### BRIEF DESCRIPTION OF DRAWINGS

Non-limiting examples will now be described with reference to the accompanying drawings, in which:

FIG. 1 is a flowchart of an example of a method of determining whether a plurality of models representing objects to be generated in an additive manufacturing operation comprise instances of similar objects having a relative rotation;

FIG. 2 is a simplified schematic drawing of a virtual fabrication chamber;

FIG. 3A is a flowchart of an example method of identifying models related by a relative rotation and FIG. 3B is an example method of modifying the identified models for generation in additive manufacturing;

FIGS. 4A to 4D are simplified schematic drawings of objects to be generated in additive manufacturing;

FIG. 5 is a simplified schematic drawing of an example apparatus;

FIG. 6 is a simplified schematic drawing of an example apparatus for additive manufacturing; and

FIG. 7 is a simplified schematic drawing of an example machine-readable medium associated with a processor.

### DETAILED DESCRIPTION

Additive manufacturing techniques (also referred to as 3D printing) may generate a three-dimensional object through the solidification of a build material. In some examples, the build material is a powder-like granular material, which may for example be a plastic, ceramic or metal powder and the properties of generated objects may depend on the type of build material and the type of solidification mechanism used. Build material may be deposited, for example on a print bed and processed layer by layer, for example within a fabrication chamber. According to one example, a suitable build material may be PA12 build material commercially referred to as V1R10A “HP PA12” available from HP Inc.

In some examples, selective solidification is achieved through directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be determined from structural design data). The fusing agent may have a composition which absorbs energy such that, when energy (for example, heat) is applied to the layer, the build material to which it has been applied heats up, coalesces and solidifies, upon cooling, to form a slice of the three-dimensional object in accordance with the pattern. In other examples, coalescence may be achieved in some other manner.

According to one example, a suitable fusing agent may be an ink-type formulation comprising carbon black, such as, for example, the fusing agent formulation commercially referred to as V1Q60A “HP fusing agent” available from HP Inc. Such a fusing agent may comprise any or any combination of an infra-red light absorber, a near infra-red light absorber, a visible light absorber and a UV light absorber. Examples of fusing agents comprising visible light absorption enhancers are dye based colored ink and pigment based colored ink, such as inks commercially referred to as CE039A and CE042A available from HP Inc.

In addition to a fusing agent, in some examples, a print agent may comprise a coalescence modifier agent, which acts to modify the effects of a fusing agent for example by reducing or increasing coalescence or to assist in producing a particular finish or appearance of an object, and such agents may therefore be termed detailing agents. In some examples, detailing agent may be used near edge surfaces of an object being printed to reduce coalescence. According to one example, a suitable detailing agent may be a formulation commercially referred to as V1Q61A “HP detailing agent” available from HP Inc. A coloring agent, for example comprising a dye or colorant, may in some examples be used as a fusing agent or a coalescence modifier agent, and/or as a print agent to provide a particular color for the object.

Although primarily described with reference to additive manufacturing apparatus which generate objects by solidification of a powder build material, other types of additive manufacturing apparatus may be used, for example a binder jet additive manufacturing apparatus, which generates an object by selectively depositing a binder material on successive layers of powder, or a fused deposition modelling (FDM) apparatus, which generates an object by selectively depositing extruded melted material.

As noted above, additive manufacturing systems may generate objects based on structural design, or object model data. This may involve a designer designing a three-dimensional model of an object to be generated, for example using a computer aided design (CAD) application. The model may define the solid portions of the object. To generate a three-dimensional object from the model using an additive manufacturing system, the model data may comprise, or can be processed to derive, slices or parallel planes of the model. Each slice may define, using data, a portion of a respective layer of build material that is to be solidified or caused to coalesce by the additive manufacturing system.

In some examples, prior to an object generation, at least one ‘virtual fabrication chamber’ may be generated. This may specify an arrangement (or a candidate or possible arrangement) of objects to be generated in a build volume or fabrication chamber of an additive manufacturing apparatus using data. In some examples, such a virtual fabrication chamber can be manually created, for example by a user “placing” or arranging models in the virtual fabrication chamber. For example, a user may modify models which represent objects to be generated within the virtual fabrication chamber and/or specify a location within a fabrication chamber that the objects represented by the data models may occupy when generated. The modifications may comprise applying rotations or translations to the objects, or the user may specify the orientation of an object. In other examples, virtual fabrication chambers may be generated automatically, for example by randomly or programmatically arranging the objects within the virtual fabrication chamber, and in some cases iterating an arrangement to improve it.

In some examples, evaluation of candidate virtual fabrication chambers has been proposed, which may be described as a nesting or object batching process, and which may seek to optimise (in some examples, within constraints) certain criteria.

In such cases, ‘nesting’ analysis has, for example, been carried out to converge on a selected candidate virtual fabrication chamber which seeks to minimise a target function which may depend on parameters such as the height of the virtual fabrication chamber, the number of objects contained within the fabrication chamber and/or the density of objects. For example, candidate virtual fabrication chambers may be compared such that the virtual fabrication chamber in which a certain number of objects can be generated in a minimum height is identified, as the lower the height of the arrangement of objects, the faster they may be generated. In some examples, this is carried out by determining a random initial solution for the arrangement (which may satisfy some basic criteria such as being contained within a printable volume and having objects which do not intersect), and determining a score for the candidate virtual fabrication chamber based on a predetermined target function. The candidate virtual fabrication chamber may then be ‘shuffled’, for example by applying a random rotation to object(s) (and in some examples, validating that the new object placement remains inside the printable volume and does not result in an intersection between objects), and the shuffled candidate virtual fabrication chamber is then scored again. This process may continue until, for example, a threshold parameter is achieved, or the arrangement associated with the best score (for example the minimum or maximum score) after a predetermined number of iterations may be selected. In other examples the objects may be moved in some non-random way within the virtual fabrication chamber rather than random shuffling, in order to create a new candidate virtual fabrication chamber.

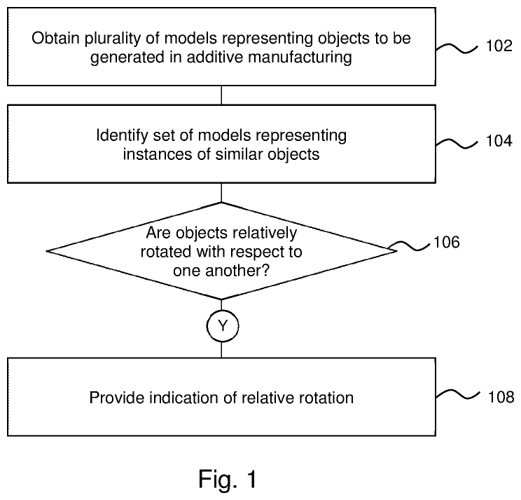

FIG. 1 is an example of a method, which may comprise a computer implemented method for determining whether a plurality of models (for example, a spatial arrangement of objects in a virtual fabrication chamber for additive manufacturing) are instances of the same object or similar objects in different orientations. In this example, the method is carried out using processing circuitry.

The method comprises, in block 102, obtaining, using at least one processor, a plurality of models, each model representing an object to be generated in an additive manufacturing operation. The models may be data models representing the geometry of the objects, for example using meshes or voxels (i.e. three dimensional pixels). The models may be generated by processing circuitry carrying out the method, or may be obtained from a memory, over a network or the like. The models may for example comprise structural design data as described above. The plurality of models may collectively represent objects which are to be generated in the same additive manufacturing operation as one another, and in some examples the intended position of object generation may also be obtained.

A plurality of models having specified relative positions and orientations may collectively represent a candidate virtual fabrication chamber for an additive manufacturing operation, the candidate virtual fabrication chamber modelling an arrangement of object models within the virtual fabrication chamber. Each model of the plurality of models may represent a single object and may define its shape and dimensions. The models may further define other properties of the objects, for example, their orientation and/or position within the virtual fabrication chamber.

The plurality of models may for example be obtained by an automatic operation such as nesting as described above, or may be a manual arrangement of objects. The plurality of models may comprise more than one instance of a model, for example, a first model may represent a first instance of an object to be generated within the virtual fabrication chamber and a second model may represent a second object to be generated within the virtual fabrication chamber. The first and second objects may be intended to be substantially the same, for example they may be the same shape and have the same dimensions, however they may be positioned in a different orientation within the virtual fabrication chamber.

Some additive manufacturing apparatus have anisotropic properties, such that when an object is generated using the apparatus, the orientation of the object when it is being generated in the fabrication chamber affects the physical properties of the finished object.

For example, some additive manufacturing apparatus generate an object from stacked layers of build material. This causes an anisotropy because the mechanical properties, such as strength (under pull, push or torsional forces) or flexibility, of a material in a direction parallel to the layers may be different from the mechanical properties of the object in a direction perpendicular to the layers.

Furthermore, the resolution of the apparatus may be different in different directions, for example the resolution may be higher in directions parallel to the plane of the layers of build material (x- and y-directions) and lower in a direction perpendicular to the build material (z-direction). In an example, the resolution in the x- and y-directions is 20 microns and the resolution in the z-direction is 80 microns.

In some examples, the additive manufacturing apparatus may induce further anisotropy, for example due to the recoating carriage direction or print head disposition. Print head disposition may also be referred to as a physical arrangement of print heads and may be related to the number of print bars and the portions of the print bars which overlap. For example, an additive manufacturing apparatus may comprise two, three, or any other number of print bars. Portions of the object which are generated in this overlapping region may, in some examples, be somewhat more prone to defects unless additional measures are taken, and/or in particular surfaces of an object which are generated orthogonally to this direction may be more prone to visible defects.

In addition, during manufacturing of an object by additive manufacturing deformations may occur resulting in an object being generated which does not have the expected dimensions. The particular deformations may depend on any or any combination of factors such as the build material used, the type of additive manufacturing, the location of the object within the fabrication chamber of the additive manufacturing apparatus, object volume and the like. The tendency for a given object dimension to deform may also be anisotropic.

In summary therefore, the orientation of an object when it is being generated can affect the mechanical, aesthetic and/or dimensional properties of the object.

The method comprises, in block 104, identifying, using at least one processor, a set of models of the plurality of models which represent instances of similar objects. For example, each of the objects represented by the plurality of models may be compared to determine if any of the objects are similar. Similar objects may be objects which have the same shape and dimensions but are relatively rotated and/or translated. In some examples similar objects may not comprise exactly the same dimensions or have exactly the same shape, but the difference and shape may be within a tolerance.

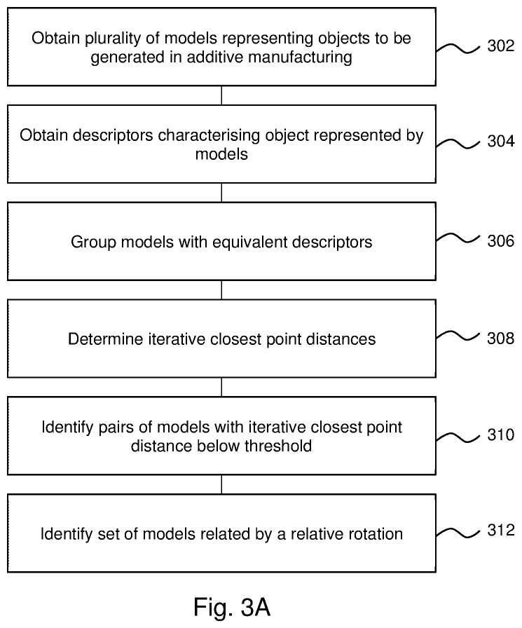

Identifying a set of models which represent instances of similar objects (and in some examples, represent the same object) may comprise considering pairs of models of the plurality of models and determining if the objects of the pair have the same shape and dimensions or are related by a translation and/or rotation. In some examples a metric may be determined to quantify the similarity of the pairs of objects, as described further in relation to the example of FIG. 3A.

In some examples, there may be no such similar objects identified, and the method may terminate.

However, assuming that models of similar objects are identified, the method comprises, in block 106, determining, using at least one processor, whether at least two of the objects represented by the models of the set of models are to be generated relatively rotated with respect to one another. Objects represented by the models may be compared, for example in pairs as described above, in order to determine if the objects represented by the models are intended to be generated in the same orientation or in a different orientation. When it is determined the objects are to be generated in the same orientation, the method may terminate because such objects, when generated, should not exhibit markedly different physical properties as a result of their orientation. However, when it is determined that the objects are to be generated in different orientations, the method may proceed to block 108.

Block 108 comprises providing, using at least one processor, an indication of the relative rotation. The indication may be an indication of the existence of the relative rotation, i.e. an indication that objects represented by the models of the set of models are relatively rotated with respect to one another. The indication may signal that, if the objects are generated according to their current orientation as specified in the virtual fabrication chamber, they may have different physical properties due to their orientations. The indication may be an indication to a user, for example a notification, such as an audible or visual indication. In some examples the indication may comprise a flag in a computing process that causes further processing to occur.

In some examples, when it is determined that similar objects are to be generated in different orientations, the method may further comprise selecting a model of the set of models, and modifying at least one non-selected model to have the same orientation as the selected model. In examples in which the plurality of models obtained in block 102 collectively represent a candidate virtual fabrication chamber for an additive manufacturing operation, the candidate virtual fabrication chamber modelling an arrangement of object models within the virtual fabrication chamber; the method may further comprise determining a modified virtual fabrication chamber comprising the selected model and the modified non-selected models. Further examples are described below.

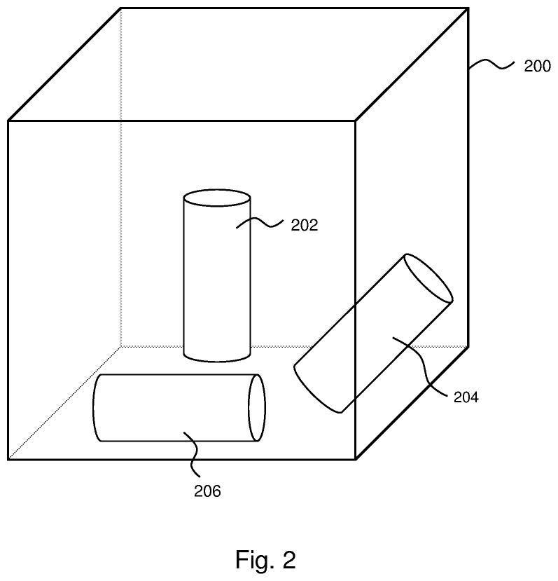

FIG. 2 shows an example of a virtual fabrication chamber 200 comprising models of three objects to be generated in additive manufacturing. The virtual fabrication chamber is a data representation of a build volume of an additive manufacturing apparatus. In this example the additive manufacturing apparatus forms objects within the fabrication chamber by depositing layers of build material and causing portions of the layers of build material to solidify so that objects are generated within the build material. The objects are represented by data models, i.e. virtual objects, in the virtual fabrication chamber 200 which define which portions of the layers of build material are to be solidified.

There are three virtual objects represented within the virtual fabrication chamber: a first virtual object 202, a second virtual object 204 and a third virtual object 206. Each of the objects to be generated are cylinders of the same dimensions. Therefore, the three virtual objects 202, 204, 206 are intended to represent instances of the same physical object, however each cylinder is rotated relative to the other cylinders. The first virtual object 202 is a cylinder wherein the axis of the cylinder is vertical (parallel to the z-direction). The second virtual object 204 is a cylinder wherein the axis of the cylinder is at an angle of 45° relative to the z-direction. The third virtual object 202 is a cylinder wherein the axis of the cylinder is horizontal (parallel to the x-direction). When the objects are generated in additive manufacturing, they are formed from discrete layers of build material so surfaces of the objects which are not parallel or perpendicular to the z-direction may have a stepped appearance. Therefore, the object generated based on the second virtual object 204 may have a stepped texture on its surface, whereas the surfaces of the object generated based on the first virtual object 202 are parallel and perpendicular to the z-direction and so an object generated based on the first virtual object 202 would not include the stepped texture when generated.

Other aesthetic or surface defects include defects caused by a lower than intended temperature, which can result in a wrinkled surface, thermal bleeding or blooming caused by a higher than intended temperature (where build material which is not intended to fuse at least partially fuses), or burr-like protrusions on an edge, which may be due to a fusing agent being drawn into an area of build material to which it was not applied by capillary action.

Furthermore, it may be intended for the generated objects to have particular physical properties, such as particular mechanical strength or flexibility in a particular direction. For example, it may be intended that the cylinders have a tensile strength greater than a threshold value parallel to their axis. Due to the anisotropy of the additive manufacturing apparatus each of the objects generated may have different strengths. In this example the object generated based on the third virtual object 206 may have the highest tensile strength parallel to its axis because the axis is parallel to layers of build material and when fusing build material, fusing within a plane may be stronger than fusing in a direction perpendicular to the plane.

In some examples herein, a given object orientation may be selected for object generation. Therefore, considering the present example, if tensile strength in the direction parallel to the axis of the cylinder is to be prioritised, the orientation of the third virtual object 206 may be selected and it may be decided to generate all the objects in this orientation. However, if the aesthetic appearance of the objects is to be prioritised, then the properties of the first object 202 may be selected and the objects may be generated in this orientation instead.

In still other examples, it may be intended that the objects are as similar as possible. In other words, while the properties may differ between orientations, in some cases, it may be intended that the properties of the objects are the same, but the nature of the properties may be of minor consideration. In some such examples, the orientation of the first 202, second 204 or third virtual object 206 may be selected as the orientation for object generation.

FIGS. 3A and 3B are examples of methods, which may comprise computer implemented methods for, respectively, identifying models related by a relative rotation and modifying the identified models for generating in additive manufacturing.

FIG. 3A may be carried out using processing circuitry, for example comprising at least one processor. Block 302 comprises obtaining a plurality of models each representing an object to be generated in an additive manufacturing operation, and may correspond to block 102 of FIG. 1. Obtaining the plurality of models may be performed at a pre-print stage, when the intended arrangement of objects is determined, which allows action to be taken as the arrangement is determined. In this example, the plurality of models collectively represent a candidate virtual fabrication chamber for an additive manufacturing operation, the candidate virtual fabrication chamber modelling an arrangement of object models within the virtual fabrication chamber. Generally, N models are obtained and are referred to as δ₁ to δ_{N}. In this example 8 models are obtained and are referred to as in {δ₁, δ₂, δ₃, δ₄, δ₅, δ₆, δ₇, δ₈}.

Block 304 comprises obtaining, for each model in the set of models, a descriptor characterising the model and/or the object represented by the model. In some examples, the descriptor characterises the object represented by the model based on properties of the object such as the shape or size of the object. The descriptor may be a numerical value or a vector. In this example, the descriptor is a vector, vᵢ, so the method comprises obtaining descriptor vectors v₁ to v_{N}.

In some examples the descriptor is an identifier such as a number or ID tag, which may identify the object being modelled. In some examples the descriptor is a descriptor vector comprising values representing any or any combination of: a number of vertices modelling the object, a number of polygons (e.g. triangles) forming a surface of the model of the object, a volume of the object, a surface area of the object, a mesh genus of the object model (e.g. the number of holes in the object), or the like. In some examples the descriptor vector comprises several, or all, of these values and it may also include other values. The values may be values which are independent of object orientation. These values may be relatively simple to compute and provide a good estimate of whether objects represented by different models are instances of the same object. If objects are instances of the same object, then they should have the same properties such as the same number of vertices or the same volume. Therefore, using a descriptor vector provides an efficient means to estimate whether the models are instances of similar or different objects without performing resource intensive computations for each pair of objects.

Block 306 comprises grouping models with equivalent descriptors. Each group of objects will then comprise objects with the same descriptor and so the objects represented by models in a group will have a degree of similarity (or in some examples may be the same object, albeit possibly arranged in a different orientation). In some examples, the grouping comprises comparing the descriptors of each pair of models. Therefore, using a descriptor to group objects provides an efficient way of grouping at least potentially similar objects.

In this example, the models are grouped into groups Gᵢ. In an example, the models δ₁, δ₅, δ₇, δ₈ may have the same descriptor vectors (i.e. v₁=v₅=v₇=v₈), and they are assigned to the same group, G₁={δ₁, δ₅, δ₇, θ₈}. The descriptor for δ₄ may be unique so it is assigned to a second group G₂={δ₄}. The descriptors for δ₂ and δ₃ may be equal, so they are assigned to a third group G₃={δ₂, δ₃}. The descriptor for δ₆ may again be unique, so it is assigned to a fourth group G₄={δ₆}. Although in this example, four groups are created, in general a different number of groups may be created depending on the number of unique descriptor vectors.

Blocks 304 and 306 are an example of grouping models of the plurality of models based on the similarity of the objects represented by the models. In some examples, a different method may be used to group the models based on the similarity of objects represented by the models according to other methods.

Blocks 304 and 306 in this example may serve as a ‘pre-filtering’ operation, which finds possibly similar models, and do not unduly consume processing resources. In this example, however, models identified in the groups are then subjected to a further check.

In particular, in this example, block 308 comprises determining, using at least one processor, for each pair of models in a group of models, an iterative closest point distance. Iterative closest point is a method which minimises the difference between two sets of points, for example it can be used to minimise the difference between the set of points represented by vertices of an object represented by a first model and vertices of an object represented by a second model. The method iteratively transforms, using translations and rotations, one of the sets of points relative to the other set of points. At each iteration, an error metric may be determined which provides a measure of how different the sets of points are from each other. The iterative closest point distance may be the value of the error metric when the iterative closest point method has been completed. For two sets of points which are related by a translation and/or rotation, but are otherwise identical, that is the relative positions of points within the set is the same, the iterative closest point method will result in an iterative closest point distance of zero. However, if the relative positions of points within each set are different then the iterative closest point distance will be greater than zero.

In more detail, the iterative closest point method may comprise matching each vertex of the first model to the closest vertex in the second model and estimating a rotation and translation which will best align the vertices of the first model with the vertices of the second model. Estimating the rotation and translation may for example be performed using a root mean square point to point distance metric minimisation techniques. The method then transforms the first model using the estimated rotation and translation. The method may then be iteratively repeated to find a better match between the two sets of vertices.

The method may comprise computing a square, symmetric matrix A^{k}={a^{k}ᵢⱼ} for each group Gₖ, wherein the coefficients of the matrix are equal to the iterative closest point distance between a pair of models (δᵢ, δⱼ).

Block 310 comprises identifying, using at least one processor, pairs of models with an iterative closest point distance below a threshold. The iterative closest point distance is a measure of how close the transformed vertices of the first model are to the vertices of the second model. If the distance is zero, then it may be determined that the objects represented by the first model and the second model are instances of the same object. If the iterative closest point distance is greater than zero, then it may be determined that the models represent different objects. In some examples it may be determined that the objects represented by the models are equivalent (or sufficiently similar to result in an identification of similar objects as discussed in relation to block 104) if the iterative closest point distance is less than a threshold.

In summary then, in this example, noting that coefficients of the matrix A^{k} described above are equal to the iterative closest point distance between a pair of models (δᵢ, δⱼ), where zero components of the matrix exist, the models represented by the zero components are identified as models which are in the same set of models.

In other examples, other methods of determining whether a pair of objects represented by models are instances of the same object, or of similar objects, may be used.

As this process of determining the iterative closest point distance is relatively computationally intense, grouping the models may reduce the number of pairs of models to be compared. However, in principle, the method may be carried out on all the models to be generated and blocks 304 and 306 are therefore optional. Therefore block 308 and 310, or block 304 and block 306, or the combination of blocks 304 to 310, all comprise examples of methods for carrying out block 104 of FIG. 1.

Block 312 comprises identifying, using at least one processor, the set of models which represent objects related by a relative rotation from a group of models. In some examples, identifying objects related by a relative rotation comprises determining whether the iterative closest point method comprised performing a rotation on the set of points. For example, the iterative closest point method may comprise, at each iteration, generating a rotation matrix used to transform the set of points. If, for example, the rotation matrices for a transformation are zero matrices, then it can be determined that no rotation was used to transform the set of points, whereas if the matrices are non-zero than the transformation may comprise a rotation. However, rotations may be identified in some other way, for example by considering the relative location of vertices of an object model.

In this way a set of models is obtained from the plurality of models which represent instances of the same object. In some examples, multiple sets of models may be identified using this method, wherein each set comprises instances of the same object, for example a first set of models may be identified which represent instances of a first object, and a second set of models may be identified which represent instances of a second, different, object.

In this example it is determined that from the first group G₁, the models {δ₁, δ₅, δ₇} are instances of the same object which are related by a relative rotation. However, it is determined that the model δ₈ is not an instance of the same object. Therefore, {δ₁, δ₅, δ₇} are assigned to the same set of models S₁={δ₁, δ₅, δ₇}, and δ₈ is assigned to a different set of models S₂={δ₈}. The remaining models are assigned to sets as follows S₃={δ₄}, S₄={δ₂, δ₃} and S₅={ϵ₆}.

When the method of FIG. 3A determines a set of models from the plurality of models, that is, when it is determined that the plurality of models comprises a set of models which represent relatively rotated instances of an object, the method may continue to perform the method of FIG. 3B. Otherwise, if no such models are found, the method may terminate.

Block 320 comprises providing, using at least one processor, a notification to a user. In this example the indication comprises a notification to notify a user that the objects generated according to the instances of the same object may have different physical properties. For example, the notification may comprise a visual alert on a display screen, or any other notification.

Block 322 comprises receiving a user input. The user input may be in response to the notification. The notification may present options for a user to select, for example the options provided to the user may comprise the set of models representing relatively rotated instances of an object. The user may select a model orientation from the set of models. The user may be provided with further information relating to each model, for example they may be provided with an estimate of the physical properties that the object would have when generated based on that model, given its orientation. For example, the user may be provided with an estimate of the aesthetic, dimensional or mechanical properties of an object when generated in the orientation represented by the model. In examples, a numerical value and/or a qualitative description of the properties may be presented to a user. For example, each of the properties for a particular model may be described as high, medium or low. Based on the user's preferences or priorities they can then select a model orientation based on the physical properties. The selection may be performed using a graphical user interface in combination with an input device, such as a keyboard, mouse or touch screen.

Block 324 comprises selecting, using at least one processor, a model from the set of models based on the user input. In other examples however selecting may not be based on user input, but instead selecting the model may comprise automatically selecting, using at least one processor, a model from the set of models based on predicted physical properties of objects generated in additive manufacturing according to the models. For example, the method may comprise determining a metric which estimates or predicts a physical property of an object generated based on each model in the set of models given its orientation. For example, a simulation may be performed to estimate a mechanical property such as tensile strength or flexibility of the object. In some examples a simulation may be performed to estimate the dimensional accuracy of an object when generated according to each of the models in the set of models, which may vary for example based on the anisotropic resolution of an additive manufacturing apparatus, or for example due to the recoating carriage direction or print head disposition. In some examples a simulation may be performed to estimate the aesthetic properties of objects according to each model in the set of models, for example the metric may be a measure of smoothness of the surface finish of the object, or the attainable color or gloss of a surface. The model may then be selected from the set of models based on one or several of these estimated properties, for example based on predetermined criteria or a predetermined hierarchy. In other examples, the user may be presented with the estimated or predicted physical property or properties, and may use that information in making their selections.

Therefore, the model may be selected based on an estimate or prediction of the physical properties of the object when generated according to a model, wherein the physical properties are any or any combination of a quantity representing dimensional accuracy, a quantity representing mechanical strength or a quantity representing physical appearance. For example, the quantity representing the dimensional accuracy may be a measure of deviation from the intended dimensions, the quantity representing mechanical strength may be a tensile strength, or the quantity representing physical appearance may be a measure of surface smoothness. In examples where the object is to be generated in a particular color, or particular colors, of build material, the model may be selected, at least in part, based on the predicted color accuracy of the generated object.

Block 326 comprises modifying, using at least one processor, at least one of the non-selected models so that the object(s) represented by the non-selected model(s) are in the same orientation as the object of the selected model. The non-selected models of the set of models may be modified by transforming (e.g. rotating) the non-selected object models so that they are in the same orientation as the object represented by the selected model (and therefore the objects will be generated in the same orientation). This may for example comprise modifying the coordinates of vertices in the object model to replicate a physical rotation. In some examples, modifying the non-selected models may comprise replacing the non-selected models with the selected model. The method may be repeated for each set of models, such that, in some examples, each set of models comprises instances of an object in the same orientation as the other models in that set of models.

In this example, if the model δ₁ is selected from a first set of models S₁={δ₁, δ₅, δ₇}, then each of the other models in the set may be replaced with, or be modified to be in the same orientation as, the first model δ₁. Similarly, if the model δ₂ is selected from the third set of models S₄={δ₂, δ₃}, then the model δ₃ may be replaced with or modified to be in the same orientation as the model δ₂. Therefore, the plurality models has been modified to become {δ₁, δ₂, δ₂, δ₄, δ₁, δ₆, δ₁, δ₈}.

As noted above, the plurality of models received in block 302 collectively represent a candidate virtual fabrication chamber for an additive manufacturing operation. Block 328 comprises determining, by at least one processor, a modified virtual fabrication chamber comprising the selected model and the modified non-selected models.

In this example, block 330 comprises generating objects represented by the modified virtual fabrication chamber in an additive manufacturing operation. For example, the virtual fabrication chamber may be ‘sliced’ into slices corresponding to layers to be generated in the additive manufacturing operation. Control data may be generated based on these slices, the control data specifying where to print agent on a layer of build material in order to generate a layer of the object(s). The objects may then be generated in a layer-wise manner by selectively solidifying portions of layers of build materials. The selective solidification may in some examples be achieved by selectively applying print agents, for example through use of ‘inkjet’ liquid distribution technologies, and applying energy, for example heat, to each layer using the plurality of fusing energy sources.

In some examples, prior to generating the control data, some additional verification may be performed on the modified virtual fabrication chamber to ensure the objects are generated as intended. For example, the method may comprise checking whether there are collisions between objects, wherein a collision is when two objects are generated within the same physical position, or generated within a small distance of each other such that a neighbouring object may cause defects or deformations in the other object. If such a verification fails, then the method may notify the user prior to generating the objects, or perform some other action to avoid generating the objects in this configuration. For example, the method may modify some models to return certain objects to their original orientation or remove some objects from the virtual fabrication chamber. In some examples, when a user is notified of a collision, they may select an option which determines how the collision is resolved, for example reversing the modifications, removing objects, or moving objects within the virtual fabrication chamber.

In some examples the method may not be performed on models which meet some criteria, for example the method may not be performed on models representing objects which are relatively elongate, because changing their orientation may increase the probability of causing a collision, whereas when the method is applied to objects with relatively similar dimensions in each direction, the probability of collisions caused by changing their orientation is relatively small.

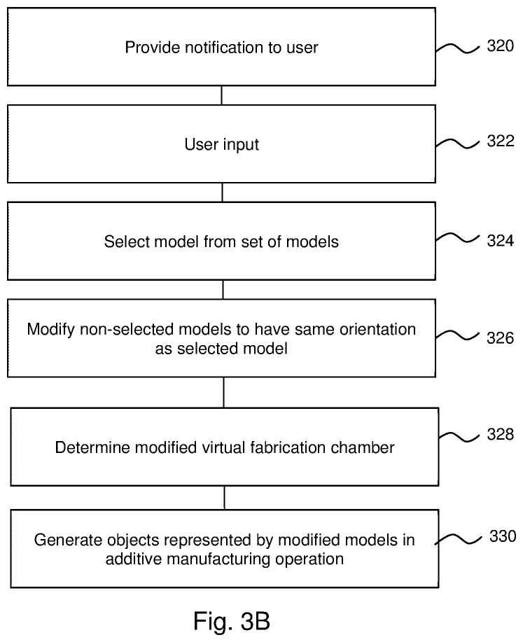

FIGS. 4A to 4D are a representation of examples of the methods described in FIG. 1 and FIGS. 3A and 3B, and they illustrate objects to be generated in additive manufacturing. Although in these figures the objects are shown as two-dimensional objects for simplicity, in practice the objects are three-dimensional objects, and the fabrication chamber is a three-dimensional space, and both the object models and the virtual fabrication chamber represent 3D space.

FIG. 4A shows a virtual fabrication chamber 400 comprising virtual objects to be generated in an additive manufacturing operation. In this example, there are eight objects to be generated, however in practice there may be any number of objects. The virtual objects are a first rectangle R1, a first triangle T1, a second triangle T2, a circle C, a second rectangle R2, a star S, a third rectangle R3 and a fourth rectangle R4. The arrangement of virtual objects within the virtual fabrication chamber 400 may have been determined by an automatic method such as a nesting process or manually. Each of the first, second and third rectangles R1, R2, R3 have a different orientation and each of the triangles T1, T2 have a different orientation.

FIGS. 4B and 4C represent a method of determining sets of models which represent instances of the similar objects i.e. they represent substantially the same object, but in a different orientation.

For each object model, a descriptor is determined, for example as described in relation to block 304. In some examples the descriptor may be a descriptor vector comprising several values, but in this example a single descriptor value is determined for each object model. In this example the descriptor value is the number of vertices of the object. Therefore, the descriptor value of the rectangles R1, R2, R3, R4 is equal to 4, the descriptor value of the circle C is 0 (or in other examples may be a high value, depending on the object model system used), the descriptor value of the triangles T1, T2 is 3 and the descriptor value of the star S is 10. The models are then grouped according to their descriptor values, as shown in FIG. 4B. The first group 420 comprises object models with a descriptor value of 4 and therefore comprises the rectangles R1, R2, R3, R4. The second group 422 comprises object models with a descriptor value equal to 0, and therefore comprises the circle C. The third group 424 comprises object models with a descriptor value equal to 3, and therefore comprises the triangles T1, T2. The fourth group 426 comprises object models with a descriptor value equal to 10, and therefore comprises the star S. Therefore, each of the groups comprises object models which are similar to each other. However, objects which are different may have the same descriptor value. For example, the fourth rectangle R4 has different dimensions compared with the other rectangles R1, R2, R3 because the long dimension of the fourth rectangle R4 is shorter than the long dimension of the other rectangles R1, R2, R3. Therefore, the fourth rectangle R4 does not represent an instance of the same object as the other rectangles R1, R2, R3.

For each group which contains more than one object model, it is determined whether object models within that group represent instances of the same object. For example an iterative closest point distance may be determined for pairs of object models within a group, as described in relation to blocks 308, 310, 312.

There is one object model in each of the second group 422 and fourth group 426. Therefore, it is determined that the object models in each of these groups are unique. However, the first group 420 and the third group 424 both comprise more than one object model, so the method continues to determine if the object models within these groups represent instances of the same object. If object models within a group are determined to represent instances of the same object then they are assigned to the same set of objects, however, if object models are determined to represent different objects, then they are assigned to different sets, for example using the method described in relation to blocks 308, 310, 312.

In this example, in FIG. 4C the object models are assigned to sets 440-448. It is determined that the first, second and third rectangles R1, R2, R3 represent instances of the same object and so they are assigned to the first set 440. However, the fourth rectangle R4 is determined to be different to the other rectangles R1, R2, R3 and so is assigned to the second set 442. The circle C was in the second group 422 with no other object models and therefore it is assigned to the third set 444. The triangles T1, T2 of the third group 424 are determined to represent instances of the same object because they have the same shape and dimensions, and the second triangle T2 is a rotation of the first triangle T1. Therefore, the triangles T1, T2 are assigned to the fourth set 446. The star S was in the fourth group 426 with no other object models and therefore it is assigned to the fifth set 448. In this way each of the object models is assigned to a set comprise instances of the same object.

For each set of object models, a model is selected, in this example, based on its physical properties, for example as described in relation to blocks 320, 322, 324. In this example the first rectangle R1 is selected from the first set 440 and the first triangle T1 is selected from the fourth set 446. Each of the second, third and fifth sets 442, 444, 448 comprise one model, which are selected by default.

FIG. 4D shows a modified virtual fabrication chamber comprising the virtual objects, wherein the virtual objects have been modified as described in relation to block 326. The second rectangle R2 and the third rectangle R3 have been modified to have the same orientation as the first rectangle R1 and the second triangle T2 has been modified to have the same orientation as the first triangle T1. The other virtual objects remain unchanged relative to their orientations in the virtual fabrication chamber 400. Therefore, the virtual fabrication chamber comprises virtual objects wherein, when generated, instances of the same object will have the same orientation. Therefore, instances of the same object generated according to the modified virtual fabrication chamber may have more similar physical properties than would be the case for the original virtual fabrication chamber.

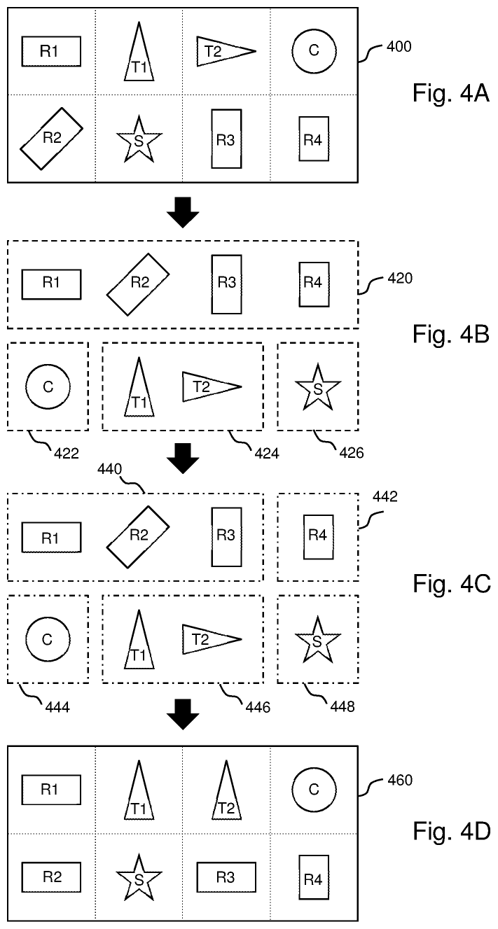

FIG. 5 shows an example of apparatus 500 comprising processing circuitry 502. The processing circuitry 502 comprises a model module 504, an orientation module 506 and an indication module 508.

In use of the apparatus 500, the model module 504 obtains a first model representing a first instance of an object and a second model representing a second instance of the object. The first and second instances of the object are objects which are intended to have the same shape, dimensions and physical properties. However, models representing instances of the same object may represent the objects in different orientations. For example, the first and second models may represent objects to be generated in a fabrication chamber of an additive manufacturing apparatus in the same additive manufacturing operation and the position and orientation of the objects may be determined manually or automatically (e.g. by a nesting method).

In use of the apparatus 500, the orientation module 506 determines if the object represented by the first model is intended to be generated by additive manufacturing in the same orientation as the object represented by the second model. As described above, if the objects represented by the models are intended to be generated in different orientations then it may be expected that the generated objects may have different physical properties, such as aesthetic, mechanical or dimensional properties.

In use of the apparatus 500, the indication module 508, when it is determined that the objects represented by the first and second models are intended to be generated in different orientations, provides an indication that the first and second models are in different orientations. The indication may be an indication that the objects are to be generated in different orientations or may be an indication that the generated objects may have different physical properties. The indication may be a notification to a user, which may for example prompt the user to select a particular orientation of the object. In some examples, the indication is a flag in a computer process which causes the computer process to execute further processing, for example halt processing, or to select a model or an intended model orientation, or the like.

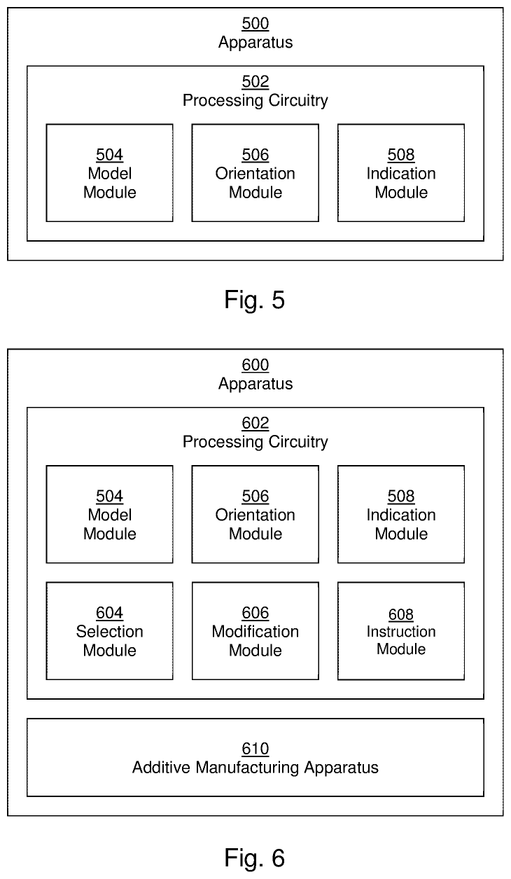

FIG. 6 shows an example of an apparatus 600, which comprises processing circuitry 602, which comprises the modules described in FIG. 6. The processing circuitry 602 further comprises a selection module 604, a modification module 606 and an instruction module 608.

In use of the apparatus 600, the selection module 604, when the indication is provided indicating the objects represented by the first and second models are in different orientations, selects the first model or the second model, for example based on predicted physical properties of an object generated in additive manufacturing according to the selected model. The selection may be a manual selection by a user or automatic selection based on predefined criteria, such as the predicted physical properties of objects generated based on the models. In some examples, the selection may be a combination of manual user selection and automatic selections, for example a subset of models may be automatically selected based on the predicted physical properties and presented to a user to make a selection from the subset.

In use of the apparatus 600, the modification module 606 modifies the non-selected model so that the object represented by the non-selected model will be generated in the same orientation as the object of the selected model. In some examples, there may be more than one non-selected model, and the modification module 606 may modify some or each of the non-selected models to be in the same orientation as the selected model. The modification module 606 may modify the non-selected models by virtually rotating the models such that the objects represented therein will have the same orientation when generated as the object represented by the selected model or it may replace the non-selected models with the selected model.

In use of the apparatus 600, the instruction module 608 determines object generation instructions for generating the objects according to the models. The object generation instructions may specify an amount of agent, such as print agent, fusing agent or detailing agent, to be applied to each of a plurality of locations on a layer of build material. For example, determining object generation instructions may comprise determining ‘slices’ of a virtual fabrication chamber containing virtual objects represented by the models, and rasterising these slices into pixels (or voxels, i.e. three-dimensional pixels). An amount of print agent (or no print agent) may be associated with each position of each slice. For example, if a region of a fabrication chamber is intended to be solidified, the object generation instructions may be determined to specify that fusing agent should be applied to a corresponding region of build material in object generation. If, however, a region of the fabrication chamber is intended to remain unsolidified, then object generation instructions may be determined to specify that no agent, or a coalescence modifying agent such as a detailing agent, may be applied thereto. In addition, the amounts of such agents may be specified in the object generation instructions and these amounts may be determined based on, for example, thermal considerations and the like. In some examples, other parameters, such as any, or any combination of heating temperatures, build material choices, an intent of the print mode, and the like, may be specified. In some examples, halftoning may be applied to determine where to place fusing agent or the like.

In some examples the apparatus 600 may comprise a verification module, which verifies whether the modified models are suitable for use in generating objects. For example, the verification module may check for collisions between objects represented by the models within a virtual fabrication chamber or may check if the objects represented by the models, after modification, are in such close proximity to each other that they may cause issues during object generation. If it is determined that the modified models are not suitable for use in generating objects, then a notification may be generated. In some examples, the models may for example be further modified to avoid such issues or be reverted to their initial state prior to modification.

The apparatus 600 further comprises an additive manufacturing apparatus 610 to generate objects.

The additive manufacturing apparatus 610 may, in use thereof, generate objects in a plurality of layers (which may correspond to respective slices of an object model/virtual fabrication chamber) according to the object generation instructions. For example, this may comprise generating objects in a layer-wise manner by selectively solidifying portions of layers of build material. The selective solidification may in some examples be achieved by selectively applying print agents, for example through use of ‘inkjet’ liquid distribution technologies, and applying energy, for example heat, to the layer. The apparatus 610 may comprise additional components not shown herein, for example any or any combination of a fabrication chamber, a print bed, printhead(s) for distributing print agents, a build material distribution system for providing layers of build material, energy sources such as heat lamps and the like.

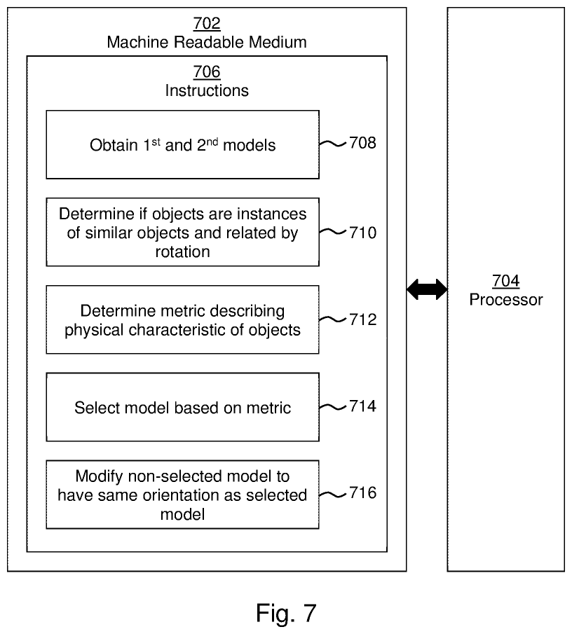

FIG. 7 shows a machine-readable medium 702 associated with a processor 704. The machine-readable medium 702 comprises instructions which, when executed by the processor 704, cause the processor 704 to carry out tasks.

In this example, the instructions 706 comprise instructions 708 to cause the processor 704 to obtain a first model and a second model, each representing an object to be generated in additive manufacturing. As described in relation to block 102 of FIG. 1 and block 302 of FIG. 3A the first and second models may represent objects to be generated in a single additive manufacturing operation in a fabrication chamber of an additive manufacturing apparatus. The instructions may be executed by processing circuitry of the additive manufacturing apparatus or other processing circuitry remote from the additive manufacturing apparatus.

The instructions 706 further comprise instructions 710 to cause the processor 704 to determine if the objects represented by the first model and second model represent instances of similar objects related by a rotation (i.e. represent relatively rotated instances of similar objects, or of the same object). Objects may be determined to be similar objects if they are instances of the same object, that is, they have the same shape and dimensions, or shape and dimension which deviate by a small amount. Determining whether objects are similar objects may comprise obtaining a metric describing some properties of the objects and comparing said metrics. Similar shapes include shapes which have a different orientation but are otherwise similar. Determining whether models are similar may be performed as described in relation to block 104 of FIG. 1 or blocks 304 to 310 of FIG. 3A.

The instructions 706 further comprise instructions 712 to, when the objects represented by the first model and the second model represent instances of similar objects related by a rotation, cause the processor 704 to determine, for each of the first model and the second model, a metric describing a physical characteristic of an object generated in additive manufacturing according to that model. The physical characteristic may be a predicted or simulated physical characteristic related to the mechanical, aesthetic or dimensional properties of the object and the metric may be a quantity representing dimensional accuracy, a quantity representing mechanical strength, or a quantity representing physical appearance. In some examples the metric may be a metric based on more than one physical property.

The instructions 706 further comprise instructions 714 to cause the processor 704 to select a model based on the metric. The selection may be performed manually by a user who is presented with the metrics, or automatically by comparing the metrics of different models within a set of models, for example as described in relation to blocks 320 to 324 of FIG. 3B.

The instructions 706 further comprise instructions 716 to cause the processor 704 to modify the non-selected model so that the object of the non-selected model has the same orientation as the object of the selected model. Modifying the non-selected model may comprise replacing the non-selected model with the selected model or rotating the object of the non-selected model so that it is in the same orientation as the object of the selected model, for example as described in relation to block 326 of FIG. 3B. When there is more than one non-selected model, the instructions 706 may cause the processor 704 to modify all the non-selected models of the set of models so that the objects represented by the non-selected models have the same orientation as the selected model. In some examples, the instructions 706 may cause the processor 704 to determine a modified virtual fabrication chamber as described in relation to block 328 of FIG. 3B.

The instructions 706 may further comprise instructions to cause the processor 704 to control an additive manufacturing apparatus to generate objects represented by the selected model and the modified non-selected models in an additive manufacturing operation, for example as described in relation to block 330.

The instructions 706 may comprise instructions to cause the processor 704 to act as any module or modules of the processing circuitry 502, 602.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine-readable instructions.

The machine-readable instructions may, for example, be executed by a general purpose computer, a special purpose computer, an embedded processor or processors of other programmable data processing devices to realize the functions described in the description and diagrams. In particular, a processor or processing apparatus may execute the machine-readable instructions. Thus, functional modules (e.g. the model module 504, the orientation module 506, the indication module 508, the selection module 604, the modification module 606 and/or the instruction module 608) of the apparatus and devices may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine-readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising, by processing circuitry:
obtaining a plurality of models, each model representing an object to be generated in an additive manufacturing operation;
identifying a set of models of the plurality of models which represent instances of similar objects;
determining whether the objects represented by the models of the set of models are to be generated relatively rotated with respect to one another; and
when objects represented by the set of models are to be generated relatively rotated with respect to one another, providing an indication of the relative rotation.

2. A method as claimed in claim 1, further comprising:
in response to the indication being provided:
selecting a model from the set of models based on predicted physical properties of objects generated in additive manufacturing according to the models; and
modifying at least one non-selected model to have the same orientation as the selected model.

3. A method as claimed in claim 1, wherein the indication comprises a notification to notify a user that the objects generated based on the determined relatively rotated models of the set may have different physical properties.

4. A method as claimed in claim 1, wherein identifying the set of models comprises:
grouping models of the plurality of models based on the similarity of the objects represented by the models; and
identifying the set of models which represent objects related by a relative rotation from a group of models.

5. A method as claimed in claim 4, wherein grouping models based on similarity of the objects represented by the models comprises:
obtaining, for each model in the set of models, a descriptor characterising the object represented by the model; and
grouping models with equivalent descriptors.

6. A method as claimed in claim 5, wherein the descriptor is a descriptor vector comprising a value representing at least one of:
a number of vertices modelling the object;
a number of polygons modelling a surface of the object;
a volume of the object;
a surface area of the object; and
a mesh genus of the object model.

7. A method as claimed in claim 1 wherein identifying a set of models of the plurality of models which represent instances of similar objects comprises:
determining, for a pair of models, an iterative closest point distance; and
identifying pairs of models with an iterative closest point distance below a threshold.

8. A method as claimed in claim 2, wherein selecting a model comprises:
selecting a model from the set of models based on a user input.

9. A method as claimed in claim 2 wherein the physical properties comprise at least one of dimensional accuracy, mechanical strength and physical appearance.

10. A method as claimed in claim 2, wherein the obtained plurality of models collectively represent a candidate virtual fabrication chamber for an additive manufacturing operation, the candidate virtual fabrication chamber modelling an arrangement of object models within the virtual fabrication chamber; and the method further comprises:
determining a modified virtual fabrication chamber comprising the selected model and the modified non-selected models; and
generating, by additive manufacturing apparatus, objects represented by the modified virtual fabrication chamber in an additive manufacturing operation.

11. An apparatus comprising processing circuitry, the processing circuitry comprising:
a model module to obtain a first model representing a first instance of an object and a second model representing a second instance of the object;
an orientation module to determine if the object represented by the first model is intended to be generated by additive manufacturing in the same orientation as the object represented by the second model; and
an indication module to, when it is determined that the objects represented by the first and second models are intended to be generated in different orientations, provide an indication that the objects represented by the first and second models are in different orientations.

12. An apparatus as claimed in claim 11, the processing circuitry further comprising:
a selection module to, when the indication is provided indicating the objects represented by the first and second models are in different orientations, select one of the first model or the second model based on predicted physical properties of an object generated in additive manufacturing according to the selected model; and
a modification module to modify the non-selected model so that the object represented by the non-selected model is to be generated in the same orientation as the object of the selected model.

13. An apparatus as claimed in claim 12, further comprising:
an instruction module to determine object generation instructions for generating the objects according to the models.

14. An apparatus as claimed in claim 13, further comprising:
an additive manufacturing apparatus to generate objects according to the instructions.

15. A machine-readable medium comprising instructions which, when executed by a processor, cause the processor to:
obtain a first model and a second model, each representing an object to be generated in additive manufacturing;
determine if the objects represented by the first model and second model represent instances of similar objects related by a rotation;
when the objects represented by the first model and the second model represent instances of similar objects related by a rotation:
determine, for each of the first model and the second model, a metric describing a physical characteristic of an object generated in additive manufacturing according to that model;
select a model based on the metric; and
modify the non-selected model so that the object of the non-selected model is to be generated in the same orientation as the object of the selected model.
